(19) United States
(12) Patent Application Publication
(10) Pub. No.: US 2026/0141906 A1
(43) Pub. Date: May 21, 2026

(54) METHOD, APPARATUS, AND MEDIUM FOR EFFICIENT ENCODING AND DECODING OF AUDIO BITSTREAMS

(71) Applicant: DOLBY INTERNATIONAL AB, Dublin (IE)

(72) Inventors: Harald MUNDT, Fürth (DE); Heiko PURNHAGEN, Sundbyberg (SE); Kristofer KJORLING, Solna (SE); Michael SCHUG, Erlangen (DE)

(73) Assignee: DOLBY INTERNATIONAL AB, Dublin (IE)

(21) Appl. No.: 19/118,263

(22) PCT Filed: Sep. 15, 2023
(86) PCT No.: PCT/EP2023/075436

§ 371 Date: Apr. 3, 2025

Related U.S. Application Data
(60) Provisional application No. 63/378,500, filed on Oct. 5, 2022.
(60) Provisional application No. 63/534,458, filed on Aug. 24, 2023.

(51) Int. Cl. G10L 19/008; G10L 19/002

(52) U.S. Cl. CPC G10L 19/008; G10L 19/002

(57) ABSTRACT

A method for generating a frame of an encoded bitstream of an audio program comprising a plurality of audio signals, wherein the frame comprises one or more independent blocks of encoded data, the method comprising, receiving, for each of the plurality of audio signals, information indicating a playback device with which the respective audio signal is associated, encoding one or more audio signals associated with a respective playback device to obtain one or more encoded audio signals, combining the one or more encoded audio signals associated with the respective playback device into a first independent block of the frame, encoding one or more other audio signals of the plurality of audio signals into one or more additional independent blocks, and combining the first independent block and the one or more additional independent blocks into the frame of the encoded bitstream.

### CROSS-REFERENCE TO RELATED APPLICATIONS

This application claims the benefit of priority from U.S. Provisional Application No. 63/378,500 filed Oct. 5, 2022 and U.S. Provisional Application No. 63/534,458 filed Aug. 24, 2023, each of which is incorporated by reference herein in its entirety.

### TECHNICAL FIELD

This disclosure relates generally to audio signal processing, and more specifically to audio source coding and decoding for low latency interchange of audio signals of immersive audio programs between devices.

### BACKGROUND

Streaming of audio is common in today's society. The audio streaming is becoming more and more demanding with the users'expectations rising on quality but also the user's setup becoming more complex with a number of speakers but also types of speakers. The streaming is normally done at some part at least over a wireless link which then puts some requirement on the wireless link to have good quality and as many probably have experienced, this is not always the case.

Therefore, there is a need to define an interchange format for use-cases where a certain format is streamed from the cloud/server and subsequently on a device transcoded to a more suitable low latency format for distribution over wireless (or, in some cases wired) links. Exemplary use-cases are in-home connectivity, as well as phone-to-automotive connectivity, although the format may be beneficial in any scenario where low latency distribution of audio signals from a single device to one or more connected devices is desired.

In addition to the audio information being sent wirelessly and streamed, there could also be other types of information being incorporated into the stream. Such other type of information will then also be affected by the quality of the wireless link and might have similar drawbacks as for the audio.

It would therefore be advantageous to overcome problems associated with wireless streaming for different types of streamed audio combined with other types of information or signals.

### BRIEF SUMMARY

An object of the present disclosure is to overcome the above problem at least partly with wireless streaming of audio combined with other types of information.

According to a first aspect of the disclosure is a method for generating a frame of an encoded bitstream of an audio program comprising a plurality of audio signals, wherein the frame comprises one or more independent blocks of encoded data, the method comprising, receiving, for each of the plurality of audio signals, information indicating a playback device with which the respective audio signal is associated, encoding one or more audio signals associated with a respective playback device to obtain one or more encoded audio signals, combining the one or more encoded audio signals associated with the respective playback device into a first independent block of the frame, encoding one or more other audio signals of the plurality of audio signals into one or more additional independent blocks, and combining the first independent block and the one or more additional independent blocks into the frame of the encoded bitstream.

According to a second aspect of the disclosure is A method for decoding one or more audio signals associated with a playback device from a frame of an encoded bitstream, wherein the frame comprises one or more independent blocks of encoded data, the method comprising, identifying, from the encoded bitstream an independent block of encoded data corresponding to the one or more audio signals associated with the playback device, extracting, from the encoded bitstream, the identified independent block of encoded data, decoding the one or more audio signals associated with the playback device from the independent block of encoded data to obtain one or more decoded audio signals, identifying, from the encoded bitstream, one or more additional independent blocks of encoded data corresponding to one or more additional audio signals, and decoding or skipping the one or more additional independent blocks of encoded data.

According to a third aspect of the disclosure is an apparatus configured to perform a method of the first and/or second aspect.

According to a fourth aspect of the disclosure is a non-transitory computer readable storage medium comprising a sequence of instructions which, when executed, cause one or more devices to perform a method of the first and/or second aspect.

Further examples of the disclosure are defined in the dependent claims.

In some examples two or more audio signals are associated with the playback device, and each of the two or more audio signals is a bandlimited signal intended for playback by a respective driver of the playback device, and wherein different encoding techniques are used for each of the bandlimited signals. In some examples, a different psychoacoustic model and/or a different bit allocation technique is used for each of the bandlimited signals. In an example, an instantaneous frame rate of the encoded signal is variable, and is constrained by a buffer fullness model.

In some examples, one or more audio signals associated with the respective playback device comprises jointly-encoding the one or more audio signals associated with the respective playback device and one or more additional audio signals associated with one or more additional playback devices into the first independent block of the frame. In an example, jointly-encoding the one or more audio signals and one or more additional audio signals comprises sharing one or more scale factors across two or more audio signals. In some examples, two or more audio signals are spatially related. In an example, two or more spatially related audio signals comprise left horizontal channels, left top channels, right horizontal channels, or right top channels.

In some examples, jointly-encoding the one or more audio signals and one or more additional audio signals comprises applying a coupling tool. In some examples the coupling tool comprises, combining two or more audio signals into a composite signal above a specified frequency; and determining, for each of the two or more audio signals, scale factors relating an energy of the composite signal and an energy of each respective signal. In some examples, jointly-encoding the one or more audio signals and one or more additional audio signals comprises applying a joint-coding tool to more than two signals.

In some examples, two or more audio signals are associated with the playback device, and each of the two or more audio signals is a bandlimited signal intended for playback by a respective driver of the playback device, and wherein different decoding techniques are used to decode the two or more audio signals. In an example, a different psychoacoustic model and/or a different bit allocation technique was used to encode each of the bandlimited signals.

For some examples, an instantaneous frame rate of the encoded bitstream is variable, and is constrained by a buffer fullness model. 15. The method of claim 11, wherein decoding the one or more audio signals associated with the playback device comprises jointly-decoding the one or more audio signals associated with the respective playback device and one or more additional audio signals associated with one or more additional playback devices from the independent block of encoded data.

In an example, jointly-decoding the one or more audio signals and one or more additional audio signals comprises applying a decoupling tool. In an example a decoupling toll comprises, extracting independently decoded signals below a specified frequency, extracting a composite signal above the specified frequency, determining respective decoupled signals above the specified frequency from the composite signal and scale factors relating an energy of the composite signal and energies of respective signals; and combining each independently decoded signal with a respective decoupled signal to obtain the jointly-decoded signals.

In the present disclosure, a frame represents a time slice of the entirety of all signals. A block stream represents a collection of signals for the duration of a session. A block represents one frame of a block stream. For digital audio with a given sampling frequency, frame size is equivalent to the number of audio samples in a frame for any audio signal. The frame size usually stays constant for the duration of a session.

A wake word may comprise one word, or a phrase comprising two or more words in a fixed order.

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

### BRIEF DESCRIPTION OF THE FIGURES

Examples of the present disclosure will be described in more detail with reference to the appended drawings. In the following drawings like reference numbers are used to refer to like elements. Although the following figures depict various examples, one or more implementations are not limited to the examples depicted in the figures.

FIG. 1 illustrates an example of in-home connectivity low latency transcoding.

FIG. 2 illustrates an example of automotive connectivity audio streaming.

FIG. 3 illustrates an example of augmented TV audio streaming by use of wireless devices.

FIG. 4 illustrates an example of audio streaming with a simple wireless speaker.

FIG. 5 illustrates an example of metadata mapping from bitstream elements to a device.

FIG. 6 illustrates an example of how to deploy a simple flexible rendering of audio streaming.

FIG. 7 illustrates an example of mapping of flexible rendering data to bitstream elements.

FIG. 8 illustrates an example of signaling of echo-references when playing audio and listening to commands with multiple devices.

FIG. 9 illustrates an example of how frames, blocks, and packets are related to each other.

FIG. 10 illustrates an example of further codec information in the current MPEG-4 structure.

FIG. 11 illustrates an example of even further codec information in the current MPEG-4 structure.

FIG. 12 illustrates an example of integrating listening capabilities and voice recognition.

FIG. 13 illustrates an example of a frame comprising multiple blocks.

FIG. 14 illustrates an example of a bitstream comprising multiple blocks.

FIG. 15 illustrates an example of blocks having different priority.

FIG. 16 illustrates an example of a bitstream comprising multiple blocks with different priority.

FIG. 17 illustrates an example of a frame having different priorities.

FIG. 18 illustrates an example of a bitstream comprising frames having different priorities.

### DETAILED DESCRIPTION

The principles of the present invention will now be described with reference to various examples illustrated in the drawings. It should be appreciated that the depiction of these examples is only to enable those skilled in the art to better understand and further implement the present invention; it is not intended for limiting the scope of the present invention in any manner.

In FIG. 1, an immersive audio stream is streamed from the cloud or server 10, and decoded on the TV or Hub device 20. The immersive audio stream may be coded in any existing format, including, for example, Dolby Digital Plus, AC-4, etc. The output is subsequently transcoded into a low latency interchange format for further transmission to connected devices 30, preferably connected over a local wireless connection, e.g., WiFi soft access point, or a Bluetooth connection. Low latency usually depends on various factors such as for example frame size, sampling rate, hardware and/or software computational resources, etc. but low latency would normally be less than 40 ms, 20 ms or 10 ms.

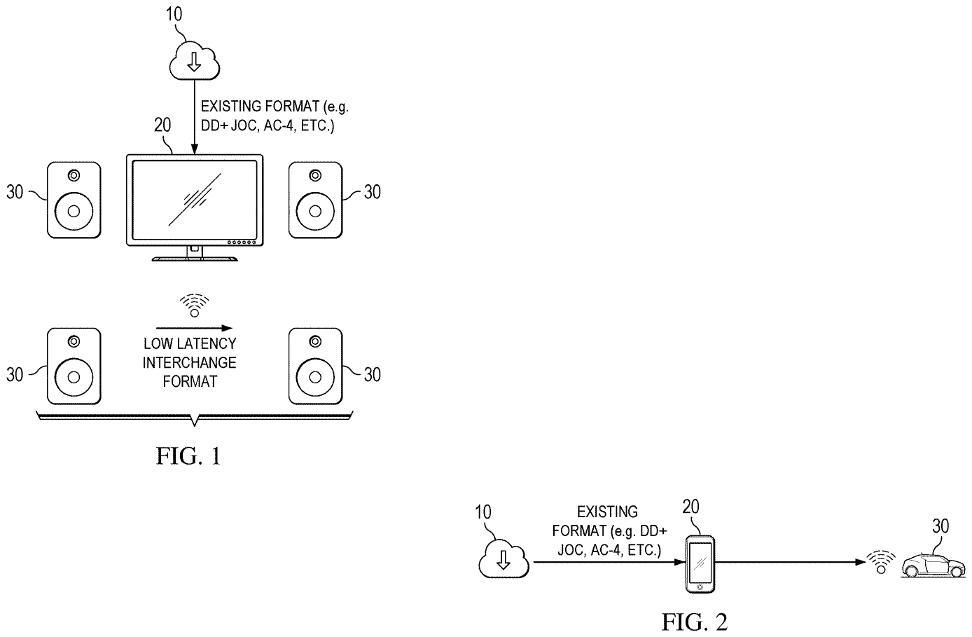

In another typical use-case a phone fetches the immersive audio stream from the cloud or a server and transcodes to the interchange format and subsequently transmits to a connected car. In the illustrated example of FIG. 2, a mobile device (e.g., a phone or tablet) 20 connects to a server 10 and receives an immersive audio stream, performs a low latency transcode to a low latency interchange format, and transmits the transcoded signal to a car 30 which supports immersive audio playback. An example of an immersive audio stream is a stream which includes audio in the Dolby Atmos format, and an example of a car 30 which supports immersive audio playback is a car configured to play back Dolby Atmos immersive formats.

In general, the interchange format preferably has, low latency, low encode and decode complexity, an ability to scale to high quality, and reasonable coding efficiency. The format preferably also supports configurable latency, so that latency can be traded against efficiency, and also error resilience, to be operable under varying connectivity conditions.

### Hub or Augmented Display with Wireless Speakers with or Without Listen Capability

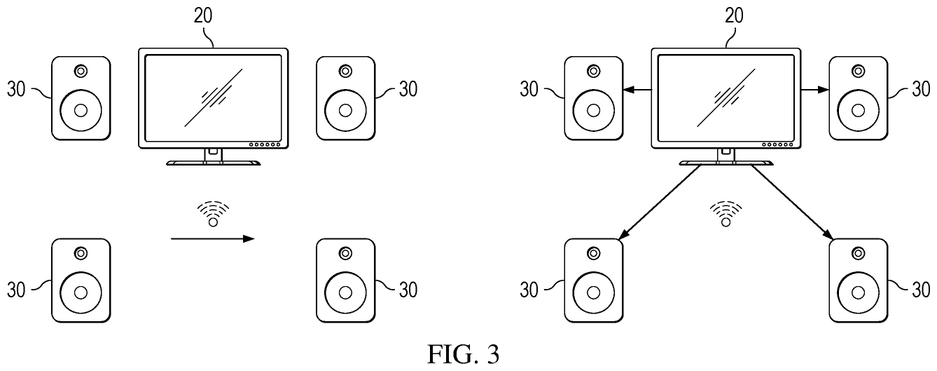

Illustrated in FIG. 3 is an example of a Hub 20 driving a set of wireless speakers 30, or a display (e.g., a television, or TV) 20, possibly with built-in speakers 30 is augmented with several wireless speakers 30. The augmentation suggests that, in examples where the display 20 includes speakers 30, the display 20 is part of the audio reproduction as well. The wireless speakers/devices 30 may be receiving the same complete signal (Broadcast Mode, illustrated to the left in FIG. 3) or an individual stream tailored for a specific device (Unicast-multipoint Mode, illustrated to the right in FIG. 3).

Each speaker may include multiple drivers, covering different frequency ranges of the same channel, or corresponding to different channels in a canonical mapping. For example, a speaker may have two drivers, one of which may be an upwards firing driver which outputs a signal corresponding to a height channel to emulate an elevated speaker. The wireless devices may have listening-capability, (e.g., “smart speakers”), and accordingly may require echo-management, which may require the speaker to receive one or more echo-references. The echo-references may be local (e.g., for the same speaker/device), or may instead represent relevant signals from other speakers/devices in the vicinity.

The speakers may be placed in arbitrary locations, in which case a so-called “flexible rendering” may be performed, whereby the rendering takes the actual position of the speakers into account (e.g., as opposed to a canonical assumption, whereby the loudspeakers are assumed to be located at fixed, predefined locations). The flexible rendering may take place in the Hub or TV, where subsequently the rendered signals are sent to the speakers/devices, either in a broadcast mode, where each of the rendered signals is sent to each device, and each respective device extracts and output the appropriate signal, or as individual streams to individual devices. Alternatively, the flexible rendering may take place locally on each device, whereby each device receives a representation of the complete immersive program, e.g., a 7.1.4 channel based immersive representation, and from that representation renders an output signal appropriate for the respective device.

The wireless devices may be connected to the Hub or TV through Soft Access Point provided by the device, or through a local access point in the home. This may impose different requirements on bitrate and latency.

### Mobile Device Projection in Automotive Applications

In another use-case, a mobile device (e.g., a phone or tablet) 20 fetches the immersive audio stream from the cloud or a server 10, transcodes the immersive audio stream to the interchange format, and subsequently transmits the transcoded stream to a connected car 30. In the example of FIG. 2, a Dolby Atmos-enabled phone 20 connects to a server 10 and receives a Dolby Atmos stream, for low latency transcoding and transmission to a Dolby Atmos-enabled car 3. In this use-case, higher bitrates may be available than in living room use-cases, and also there may be different characteristics of the wireless channel. Possible reasons for the higher bitrate in the car use-case is due to less noisy wireless environment since the car acts as a kind of a faraday cage and shields the inside car environment from outside wireless disturbance, compared to the living room where all wireless devices such as from neighbors, other rooms and so on are adding noise to the wireless environment. At the same time there are normally very few wireless devices in the car that are competing for the available wireless bandwidth, compared to in the living-room use case where normally all the wireless devices in the household are competing for the available bandwidth, including the living room wireless devices.

For this use-case it is envisioned that the signal to be transcoded by the mobile device and transmitted to the car may be a channel based immersive representation, an object-based representation, a scene-based representation (e.g., and Ambisonics representation), or even a combination of different representations. For this example, the different rendering architectures and broadcast vs. multipoint may not be relevant, as generally the complete presentation will be transferred from the mobile device to a single end-point (e.g., the car).

### Description of the Interchange Format

The immersive interchange format is built on a modified discrete cosine transform (MDCT) with perceptually motivated quantization and coding. It has configurable latency, e.g., support for different transform sizes at a given sampling rate. Exemplary frame sizes are 128, 256, 512, 1024 and 120, 240, 480, 960 and 192, 384, 768 samples at sampling rates of 48 kHz and 44.1 kHz.

The format may support mono, stereo, 5.1 and other channel configurations, including immersive channel configurations (e.g., including, but not limited to, 5.1.2, 5.1.4, 7.1.2, 7.1.4, 9.1.6, and 22.2, or any other channel configuration consisting of unique channels as specified in ISO/IEC 23091-3:2018, Table-2). The format may also support object-based audio and scene-based representations, such as Ambisonics (e.g., first order or higher-order). The format may also use a signaling scheme that is suitable for integration with existing formats (e.g., such as those described in ISO/IEC 14496-3, which may also be referred to as the MPEG-4 Audio Standard, ISO 14496-1 which may also be referred to as the MPEG-4 Systems Standard, ISO 14496-12 which may also be referred to as the ISO Base Media File Format Standard and/or ISO 14496-14 which may also be referred to as the MP4 File Format Standard).

Furthermore, the system may have support for the ability to skip parts of the syntax elements and only decode relevant parts for a given speaker, support for metadata controlled flex-rendering aspects such as delay alignment, level adjustment, and equalization, support for the use of smart-speakers (including the scenario where a set of signals is sent that allows to feed each of the driver/loudspeaker in a smart speaker independently) with listening capability, and associated support for echo-management by signaling of echo-references, support for quantization and coding in the MDCT domain with both low overlap windows as well as 50% overlap windows, and/or support for filtering along the frequency axis in the MDCT domain to do temporal shaping of quantization noise, e.g., TNS (Temporal Noise Shaping). Thus, in various examples the overlap windows are symmetric or asymmetric.

The disclosed interchange format may in some examples provide for improved joint channel coding, to take advantage of increased correlation between signals in the flexible rendering use-case, improved coding efficiency by shared scale factors across channel elements, inclusion of high frequency reconstruction and noise addition techniques in the MDCT domain, assorted improvements over legacy coding structures to allow for better efficiency and suitability to the use-cases at hand.

In some examples of controlling individual playback devices in broadcast mode, skippable blocks and metadata may be used. In a broadcast mode setting, each wireless device will need to play the relevant part of the complete audio for the specific drivers/channels that correspond to the specific device. This implies that the device needs to know what parts of the stream are relevant for that device, and extract those parts from the complete audio stream being broadcast. In order to enable low complexity decoding operations, it is preferable if the stream is constructed in a manner so that the decoder for the specific device can efficiently skip over elements that are not relevant for decoding to the elements that are relevant for the device and the given drivers on the device.

However, it should be noted that there may be benefits (from a compression perspective) to still allow for joint coding between signals that are destined for different devices (e.g., in the most simplistic scenario the left and right channel of a stereo presentation).

Hence, the format may: enable “skippable blocks” in the bitstream to enable efficient decoding of the parts only relevant for the specific device, include metadata that enables flexible mapping of one or more skippable blocks to a specific device, while retaining the ability to apply joint coding techniques between signals corresponding to different speakers/devices.

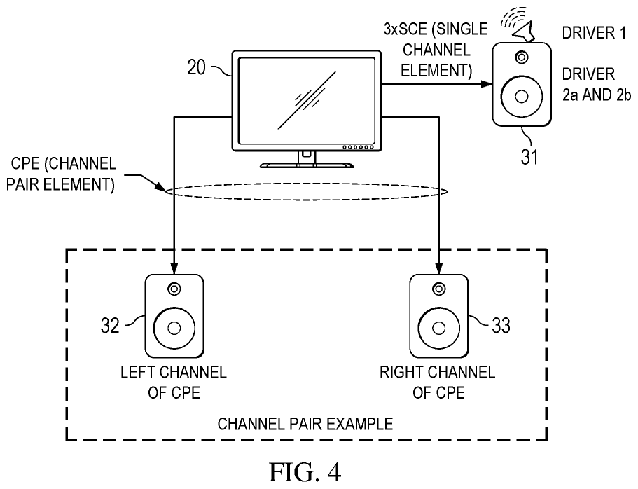

In FIG. 4, an example of an arbitrary set-up is shown. There are three connected wireless devices 31,32,33, of which two are single channel speakers 32,33 (meaning one channel of audio) and one speaker 31 is a more advanced speaker 31 with three different drivers and thereby operating on three different signals. The first speaker 31 operates on 3 individual signals in this example, while the second and third speakers 32,33 operate on a stereo representation (e.g., Left and Right). As such, it may be beneficial to do joint coding of the signals of the stereo representation.

Given the above scenario, the format specifies a bitstream containing skippable blocks so that the first device can extract only the relevant parts of the stream for decoding the signals for that speaker, while decoder complexity vs. efficiency may be traded off for the stereo pair by constructing a signal where each speaker needs to decode two signals to output a single signal, with the upside that joint coding can be performed.

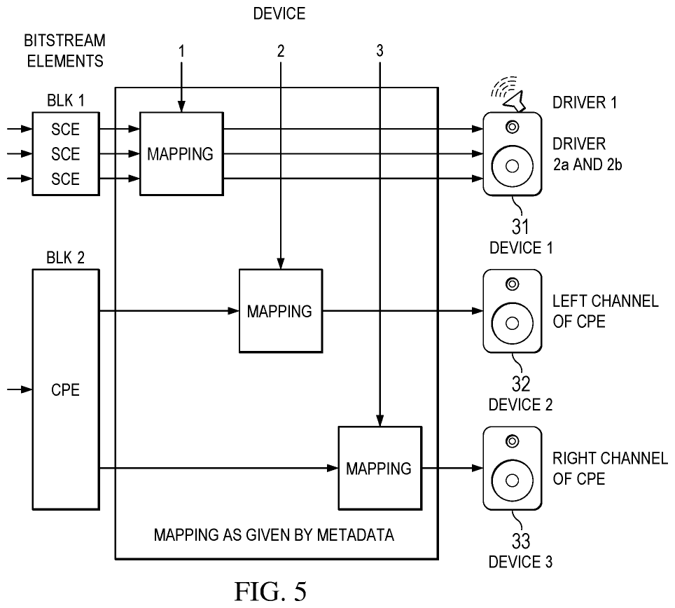

The format specifies a metadata format to enable a general and flexible representation which maps specific ones of a plurality of skippable blocks to one or more devices. This is illustrated in FIG. 5, where the mapping may be represented as a matrix that associates each device 31,32,33 to one or more bitstream elements, so that the decoder for a given device will know what bitstream elements to output and decode.

For instance, in the example of FIG. 5, a first block or skip block Blk1 includes 3 single channel elements (one for each driver of device 1 31), while a second block or skip block Blk2 contains a channel pair element, which may include jointly-coded versions of the signals to be output by Devices 2 32 and 3 33. Device 1 31 extracts mapping metadata and determines that the signals it requires are in skip block 1 Blk1. It therefore extracts skip block 1 Blk1, decodes the three single channel elements therein, and provides them to drivers 1, 2a, and 2b, respectively.

Furthermore, device 1 31 ignores skip block 2, Blk2. Similarly, Device 2 32 extracts mapping metadata and determines that the signals it requires are in skip block 2, Blk2. Device 2 32 therefore skips skip block 1, Blk1 and extracts skip block 2, Blk2. Device 2 32 decodes the channel pair element and provides the left channel output of the CPE to its drivers. Similarly, Device 3 33 extracts mapping metadata and determines that the signals it requires are in skip block 2 Blk2, Device 3 33 therefore skips skip block 1 Blk1 and also extracts skip block 2 Blk2. Device 3 33 decodes the channel pair element and provides the right channel output of the CPE to its drivers.

In some examples, Device 2 32 may determine that it requires only a subset of the signals from skip block 2 Blk2. In such examples, when possible, Device 2 32 may perform only a subset of the operations required to fully decode the signals in skip block 2 Blk2. Specifically, in the example of FIG. 5, Device 2 32 may only perform those processing operations required to extract the left channel of the CPE, thus enabling a reduction of computational complexity. Similarly, Device 3 33 may only perform those processing operations required to extract the right channel of the CPE.

For example, in the case of FIG. 5, there may be times where the CPE is coded using joint-channel coding, and other times where it is coded using independent channel coding. During times when the CPE is coded using independent channel coding, Device 2 32 may extract only the first (e.g., left) channel of the CPE, while Device 3 33 may extract only the second (e.g., right) channel of the CPE.

In another example, the channels of the CPE may be coded using joint-channel coding, in which case devices 2 32 and 3 33 must extract two intermediate channels of the CPE. However, Device 2 32 may still be able to operate with reduced computational complexity by only performing those operations required to extract the Left channel from the intermediate channels. Similarly, Device 3 33 may still be able to operate with reduced computational complexity by only performing those operations required to extract the Right channel from the intermediate decoded channels.

Depending on the specifics of the joint-channel coding, other optimizations may be possible. The identity of each of the different devices/decoders may be defined during a system initialization or set-up phase. Such a set-up is common and generally involves measuring the acoustics of a room, speaker distance to sweet spot, and so on.

### Distribution of Flexible Rendering (Pre-Encode and Post Decode) and the Application of Delay etc. Post Decoder

For a use-case where flexible rendering is applied in a Hub/TV prior to sending the relevant signals to the specific devices/speakers, the rendering may create signals that, from a coding perspective, are more difficult to code, for example when considering joint coding of such signals. One reason is that flexible rendering may apply different delays, equalization, and/or gain adjustments for different devices (e.g., depending on placement of a speaker relative to the other speakers and the listener). It would also be possible to pre-set information for example the gain and delay at an initial set-up and flexibly only render the equalization. Other variants of pre-set information and flexible rendering information may also be possible in other examples. Note that, in this document, the term “gain” should be interpreted to mean any level adjustment (e.g., attenuation, amplification, or pass-through), rather than being restricted to only certain level adjustments (e.g., amplification).

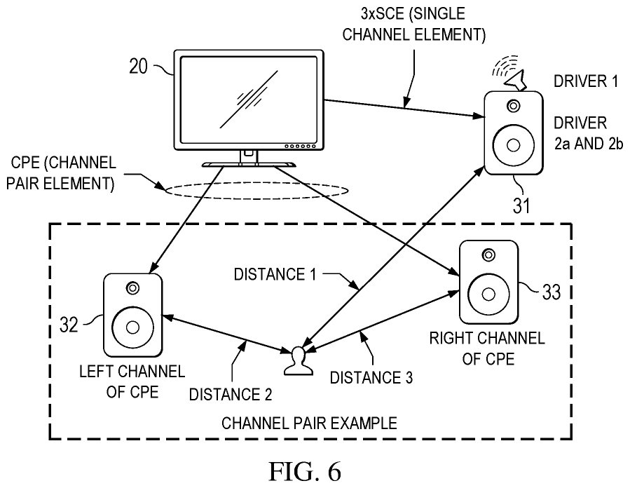

In the example of FIG. 6, the right channel 33 and left channel 32 speakers are given different latencies, reflecting different placements relative to the listener (e.g., since the speakers 32,33 may not be equidistant to the listener, different latencies may be applied to the signals output from the speakers 32,33 so that coherent sounds from different speakers 32,33 arrive at the listener at the same time). The introduction of such differing latencies to coherent signals intended for playback over different speakers 31,32,33 makes joint coding of such signals challenging.

To address this challenge, aspects of the flexible rendering process may be parameterized and applied in the endpoint device after decoding of the signal.

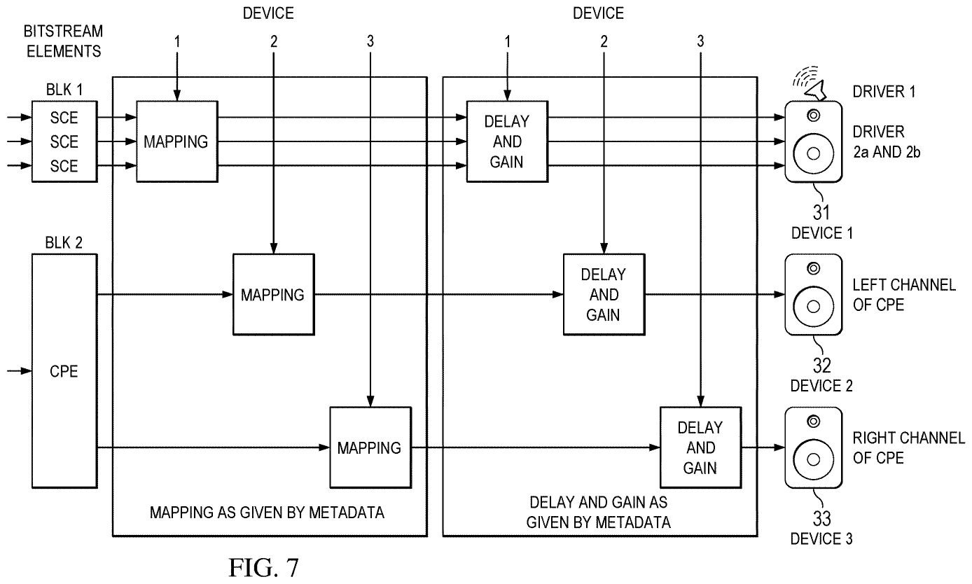

In the example of FIG. 7, delay and gain values for each device are parameterized and included in the encoded signals sent to the respective speakers 31,32,33. The respective signals may be decoded by respective devices 31,32,33, which then may introduce the parameterized gain and delay values to respective decoded signals.

In an example, such as that shown in FIG. 7, where coded signals for different devices 31,32,33 are sent in separable blocks (e.g., skippable blocks), the parameters (e.g., delay and gain) may also be sent in separable blocks, such that a device 31,32,33 may extract only a subset of the parameters required for that device 31,32,33 and ignore (and skip over) those parameters which are not required for that device 31,32,33. In such case, mapping metadata indicating which parameters are included in which blocks may be provided to each device.

Note also that, although FIG. 7 only indicates delay and gain parameters, other parameters may also be included, such as equalization parameters. The equalization parameters may, for example, comprise a plurality of gains to be applied to different frequency regions, an indication of a predetermined equalization curve to be applied by the playback device 31,32,33, one or more sets of infinite impulse response (IIR) or finite impulse response (FIR) filter coefficients, a set of biquad filter coefficients, parameters specifying characteristics of a parametric equalizer, as well as other parameters for specifying equalization known to those skilled in the art.

Furthermore, the parameterization of flexible rendering aspects need not be static, and can be dynamic (for example, in case a listener moves during playback back of an audio program). As such, it may be preferable to allow for the parameters to change dynamically. In cases where one or more parameters change during an audio program, the device may interpolate between previous delay and/or gain parameters and updated delay and/or gain parameters to provide a smooth transition. This may be particularly useful in situations where the system dynamically tracks the location of the listener, and correspondingly updates the sweet-spot for dynamic rendering.

As has also been noted, and will be described subsequently, when flexible rendering is applied, increased level of correlation between channels may occur, and this can be exploited by a more flexible joint coding.

### Echo-Reference Coding and Signaling

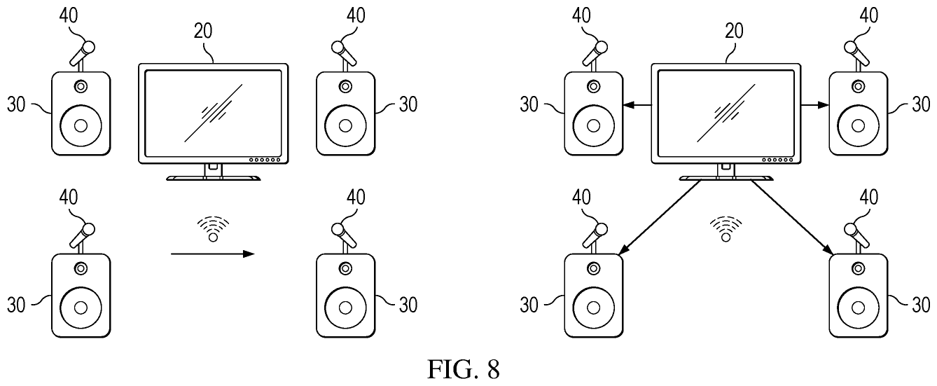

For a use-case as outlined in FIG. 8, where there are multiple device/speakers 30 operating together receiving the signal in either a broadcast Mode, illustrated to the left in FIG. 8, or in a Unicast-multipoint mode, illustrated to the right of FIG. 8, and at the same time there are microphones 40 on the device 30 to enable “listen” capability, the need for echo-management arises.

When performing echo-management with multiple speakers/devices, it may be beneficial to use echo-references from more than just the local speaker device. As an example, one device may be placed close to another device, and hence the signal from the device in close vicinity will impact echo-management of the device with the active microphone. In a broadcast mode use-case, each device receives the signals for all of the devices. When a device has signals for other devices, it may be beneficial to use those signals as echo-references. To do so, it is necessary to signal to a particular device which of the signals may be used as echo-references for which other devices.

In one example this may be done by providing metadata that not only maps the channels/signals to be played out (from the whole set) by specific speakers/devices, but also maps the channels/signals to be used as echo-references (from the whole set) for specific speakers/devices. Such metadata or signaling may be dynamic, enabling the indication of the preferred echo-reference to vary over time.

For a use-case where each device/speaker receives only the specific signals it is to play out, in order to provide appropriate echo-references, it may be necessary to transmit additional signals (e.g., echo-reference signals) to each device/speaker. Again, to do so, it is necessary to provide device-specific signaling so that each device can select the appropriate signal for playout and the appropriate signals for echo-management.

Since the signals for echo-management are only used by the device for performing echo management, and are not played out by the device for the listener, the echo-reference signals may be coded or represented differently than the signals intended for playback by the device. Specifically, because successful echo-management may be achieved with a signal coded at a lower rate than what would normally be used for playout for a listener, additional compression tools, such as a parametric representation of the signal, which may not be suitable for playout to a listener at all, but that captures the necessary features of the audio signal, may provide good echo-management at significantly reduced transmission cost.

### Assorted Syntax Elements

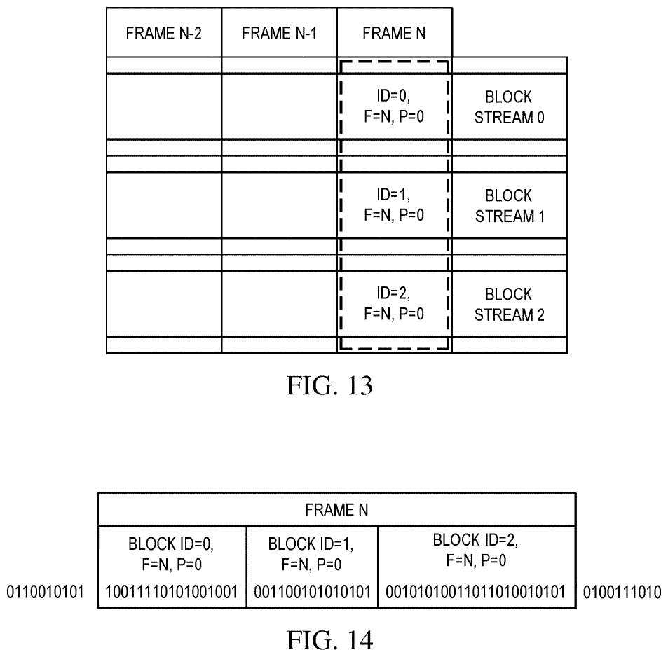

In some examples, blocks are used for optimizing transport of audio. In the described format, each frame may be split up into blocks, as described above in relation to skippable blocks. A block may be identified by the frame number to which it belongs, a block ID which may be used to associate consecutive blocks from different frames with the same ID to a block stream, and a priority for retransmission. One example of the above is a stream with multiple frames N-2, N-1 and N, frame N comprises multiple blocks identified as ID1, ID2, ID3 which are illustrated in FIG. 13. An example of this stream but in a bitstream format is illustrated in FIG. 14. In some examples, for audio signals of an immersive audio program, the block ID of a block may indicate which set of signals of the entire immersive audio program is carried by that block.

A use case for the described format is the reliable transmission of audio over a wireless network such as Wifi at low latency. Wifi, for example, uses a packet-based network protocol. Packet sizes are usually limited. A typical maximum packet size in IP networks is 1500 bytes. The block-based architecture of the stream allows for flexibility when assembling packets for transmission. For instance, packets with smaller frames can be filled up with retransmitted blocks from other frames. Large frames can be split on block boundaries before packetizing them to reduce dependencies between packets on the network protocol layer.

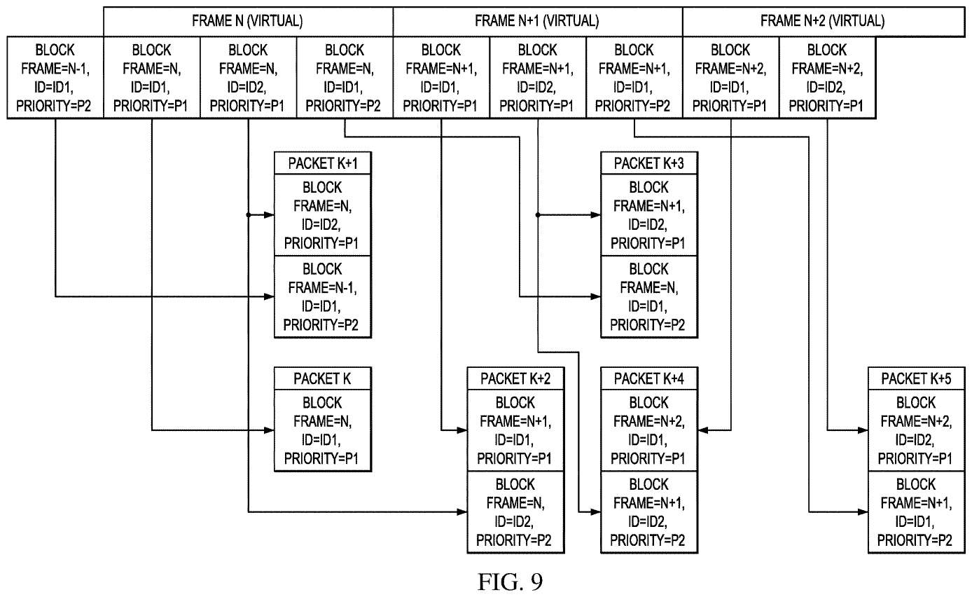

FIG. 9 shows the relationship between frames, blocks, and packets. A frame carries audio data, preferably all audio data, that represents a continuous segment of an audio signal with a start time, an end time, and a duration which is the difference of end time and start time. The continuous segment may comprise a time period according to ISO/IEC 14496-3, subpart 4, section 4.5.2.1.1. Section 4.5.2.1.1 describes the content of a raw_data_block(). A frame may also carry redundant representations of that segment e.g., encoded at a lower data rate. After encoding, that frame can be split into blocks. The blocks can be combined into packets for transmission over a packet-based network. Blocks from different frames can be combined in a single packet, and/or may be sent out of order.

In an example, blocks are used for addressing individual devices. Packets of data are received by individual devices or related groups of devices. The concept of skippable blocks may be used to address individual devices or related groups of devices. Even if the network operates in a broadcast mode when sending packets to different devices, the processing of audio (e.g., decoding, rendering, etc.) can be reduced to the blocks that are addressed to that device. All other blocks, even if received within the same packet, can simply be skipped over. In some examples, blocks may be brought in the right order, based on their decode or presentation time. Retransmitted blocks with lower priority may be removed if the same block with higher priority has also been received. The stream of blocks may then be fed to the decoder.

In some examples, the configuration of the stream and the devices are sent out of band. The codec allows for setting up a connection where the audio streams are transmitted at comparably high rate but with low latency. The configuration of such a connection may stay stable over the duration of such a connection. In that case, instead of making the configuration part of the audio stream, it can be transmitted out of band. For such an out of band transmission, even different networks, or network protocols may be used. For instance, the audio stream may use User Datagram Profile (UDP) for low latency transmission while the configuration may use Transmission Control Protocol (TCP) to ensure a reliable transmission of the configuration.

### Enabling the Codec in the Context of MPEG-4 Audio

One specific application of the present technology is use within MPEG-4 Audio. In MPEG-4 Audio, different AOTs (Audio Object Type) are defined for different codec technologies. For the format described in this document, a new AOT may be defined, which allows for specific signaling and data to that format. Furthermore, the configuration of a decoder in MPEG-4 is done in the DecoderSpecificInfo() payload that in turn carries the AudioSpecificConfig() payload. In the latter, certain general signaling agnostic of the specific format is defined, such as sampling rate and channel configurations, as well as specific info for the specific AOT. For conventional formats, where the whole stream is decoded by a single device, this may make sense. However, in a Broadcast Mode, where a single stream is transmitted to several decoders, with each respective decoder decoding only parts of the stream, up-front channel configuration signaling (as a means to set up the output functionality of the device) may be suboptimal.

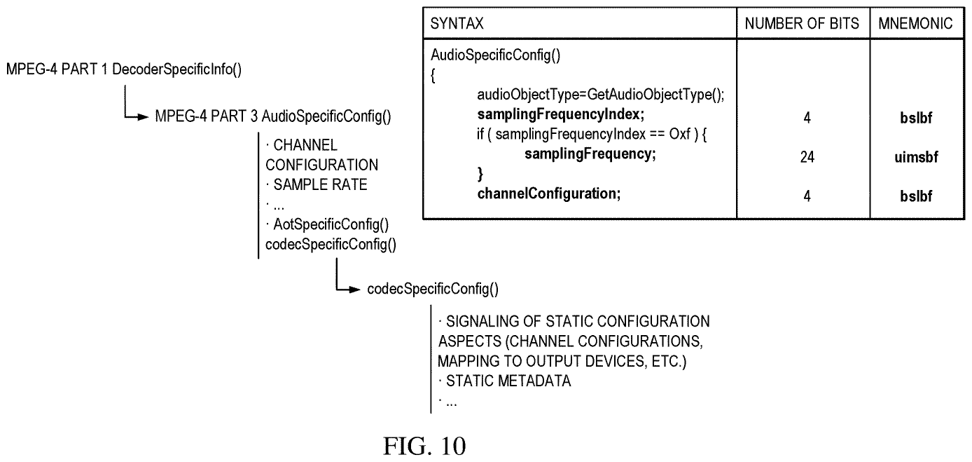

FIG. 10 illustrates the conventional MPEG-4 high level structure (in black), with modifications in grey. To support the Broadcast use-case, a codecSepcificConfig() (where “codec” may be a generic placeholder name) is defined, in which signaling is re-defined for specific use-cases, so that it is possible to map specific channel elements to specific devices, as well as to include other relevant static parameters. An MPEG-4 element channelConfiguration having a value of “0” is defined as channel configuration defined in codecSpecificConfig. Hence, this value may be used to enable a revision of the signaling of channel configurations inside the codec specific config.

Further, in the spirit of MPEG-4, raw payloads are specified for the specific decoder at hand, given that the codecSpecificConfig() is decodable. However, the format ensures that dynamic metadata are part of the raw payloads and ensure that length information is available for all of the raw payloads, so that the decoder easily can skip over elements that are not relevant for the specific device.

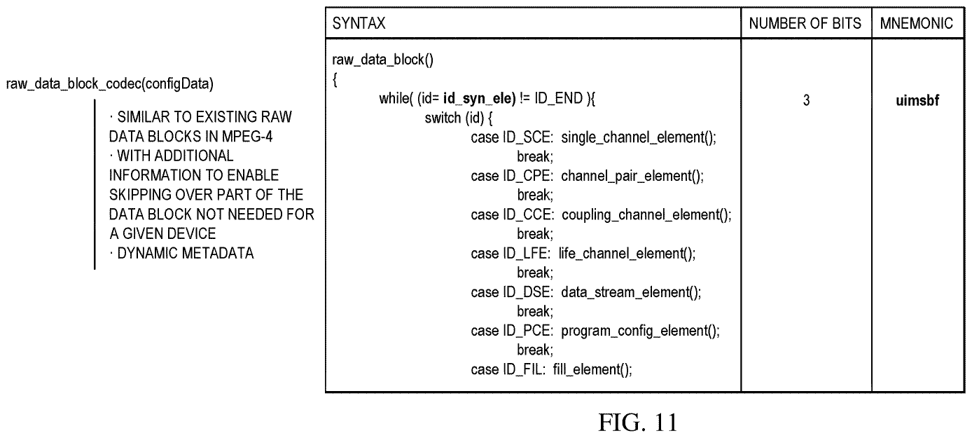

In FIG. 11, part of an example raw_data_block as defined in MPEG-4 is given to the right. The raw data block contains channel elements (single channel elements (SCE) or channel pair elements (CPE)) in a given order. However, a decoder wishing to skip over parts of these channel elements which may not be relevant to the output device at hand would, in a conventional MPEG-4 Audio syntax have to parse (and to some extent also decode) all the channel elements to be able to extract the relevant parts. In the new raw data block illustrated to the left in FIG. 11, the contents would be made up from skippable blocks so that the decoder can skip over the irrelevant parts and decode only the channel elements indicated by the metadata as being relevant for the device at hand. In an example, the skippable blocks comprise the raw_data_block, and related information.

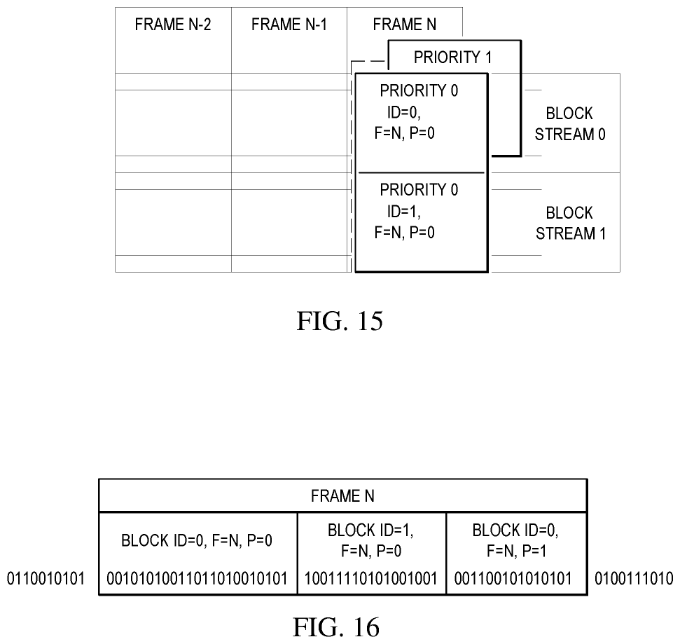

It will also be possible to use blocks for retransmission. Each frame can be split up into blocks, as described in the skippable blocks section above. A block can be identified by the frame number to which it belongs, a block ID which may be used to associate consecutive blocks from different frames with the same ID to a block stream, and a priority for retransmission, as illustrated in FIGS. 15 and 16. For instance, a high priority for retransmission (e.g., indicated in FIGS. 15 and 16 with Priority 0) signals that a block shall be preferred at the receiver over another block with the same block ID and frame counter but lower priority for retransmission (e.g., indicated in FIGS. 15 and 16 with Priority 1). Note that, as in the example of FIGS. 15 and 16, priority may decrease as priority index increases (e.g., Priority 1 may be lower priority than Priority 0), while in other examples, priority may increase as priority index increases (e.g., Priority 0 is lower priority than Priority 1). Still other examples will be evident to the skilled person.

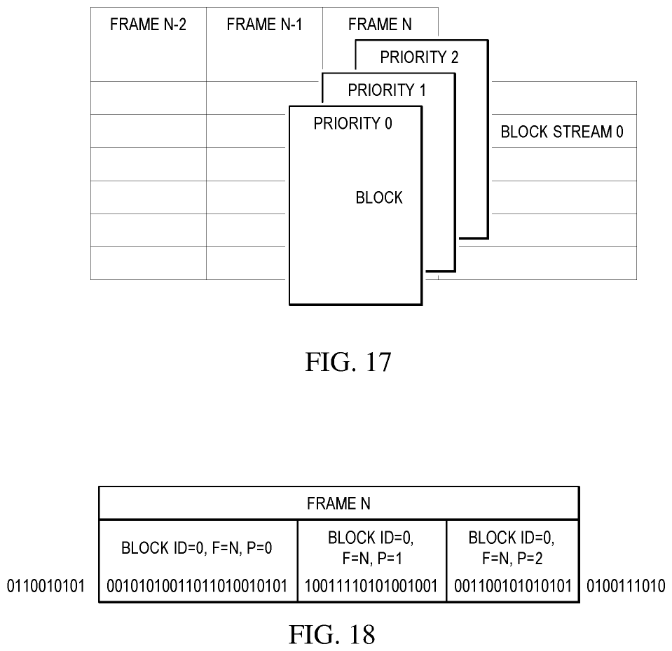

The syntax may support retransmission of audio elements. For retransmission, various quality levels may be supported. The retransmitted blocks may therefore carry a ‘priority’ flag to indicate which blocks with the same block ID should take priority for the decoder, because blocks received with the same frame counter and block ID are redundant, and hence for the decoder mutually exclusive, as illustrated in FIGS. 17 and 18.

The retransmission of blocks may be done at a reduced data rate. Such a reduced data rate may be achieved by reducing the signal to noise ratio of the audio signal, reducing the bandwidth of the audio signal, reducing the channel count of the audio signal (e.g., as described in U.S. Pat. No. 11,289,103, which is incorporated by reference in its entirety), or any combination thereof. In order for the decoder to pick the audio block that provides the best possible quality, the block that provides the highest quality signals may have the highest decoding priority, the block with the second highest quality signals may have the second highest priority, and so on.

The blocks may also be retransmitted at the same quality level. In such a case, the priority may reflect the latency of the retransmitted block.

### Tools to Improve Core Coding Efficiency

Further examples could allow for sharing MDCT Quantization Scale Factors over Channel Elements. In some cases, it may be possible to share MDCT scale factors over certain channels to reduce the associated side bit rate. Furthermore, scale factor sharing could be extended to different Channel Elements, for example as for 7.1.4 input. Usage of shared scale factors may be indicated by 2 signaling bits allowing for 3 active configurations. One possible configuration would be to share scale factors in left horizontal channels, left top channels, right horizontal channels, and right top channels. The specific syntax may be aligned to the skippable blocks concept, to ensure that scale factors are only shared within skip blocks.

It would also be possible to have joint coding of more than two channels. In the example illustrated in FIGS. 4, 5, 6, and 7 block Blk 1 carries three SCEs, one for each of the drivers in the smart speaker considered in this scenario. In such a situation, in can be beneficial to enable joint coding of not just two channels (as is provided by the CPE, which could be extended to include the stereo prediction, e. g, the MDCT-based complex prediction stereo tool as described in ISO/IEC 23003-3, referred to as MPEG-D USAC), but more than two channels, for example as described in the SAP (Stereo Audio Processing) tool introduced in ETSI TS 103 190.

Similarly, it is noted that in the case of flexible rendering, there may be a high amount of correlation between signals across devices. For such signals, it may be beneficial to construct skip blocks that cover multiple devices and allow for joint channel coding to be applied over more than two channels using the tools outlined above.

Another joint channel coding tool which may be used, for certain transform lengths, is channel coupling, in which a composite channel and scale factor information is transmitted for mid and high frequencies. This may provide bitrate reduction for playback in the good quality range. For example, using a channel coupling tool for frames with a transform length of 256, corresponding to a frame length around 256 samples for low latency coding, may be beneficial.

This disclosure would also allow for efficient coding of bandlimited signals. In the scenario where separate signals feeding different drivers of a smart speaker are sent, some of these signals can be bandlimited, such as, for example, the case of a three-way driver configuration with woofer, mid-range, and tweeter. Hence, efficient encoding of such bandlimited signals is desirable, which can translate into specifically tuned psychoacoustic models and bit allocation strategies as well as potential modifications of the syntax to handle such scenarios with improved coding efficiency and/or reduced computational complexity (e.g., enabling the use of a bandlimited IMDCT for the woofer feed).

In some examples, combination of high frequency reconstruction and noise addition in the MDCT domain would be possible. Modern audio codecs are typically designed to support parametric coding techniques, and similarly here one can envision the inclusion of e.g., high frequency reconstruction methods in the MDCT domain to retain the low latency and perform noise addition schemes in the MDCT domain to manage tonal to noise ratio in the reconstructed high band. Such parametric coding techniques may be useful especially for lower operation points, and particularly in scenarios where re-transmission occurs as part of an FEC (Forward Error Correction) scheme, where typically the main signal is transmitted, and then same signal is re-transmitted at a lower bitrate in a delayed fashion.

These examples would further allow for peak complexity reduction in the encoder. This would be applicable if the buffer model restrictions for a constant bitrate transport channel are not in place. In constant bitrate with buffer mode, it could happen that after quantization and counting, the resulting number of bits to be used for the to be encoded frame is above the limit of allowed bits. At least one new, coarser quantization and bit counting step need to be conducted to fulfill the bit requirement. If this limitation is more relaxed, the encoder could keep the first quantization result and would be done at a slightly higher instantaneous bitrate. Still an encoder behavior similar to that of the constant bitrate with buffer model encoder can be achieved, by using the same bit reservoir control mechanism, together with a virtual buffer fullness that gets updated according to an encoder obeying the buffer requirements. This would save additional quantization and bit counting steps and the resulting audio quality would be the same or better compared to the constant bitrate case with the drawback of a slightly increased overall bitrate.

### Return Channel Concept

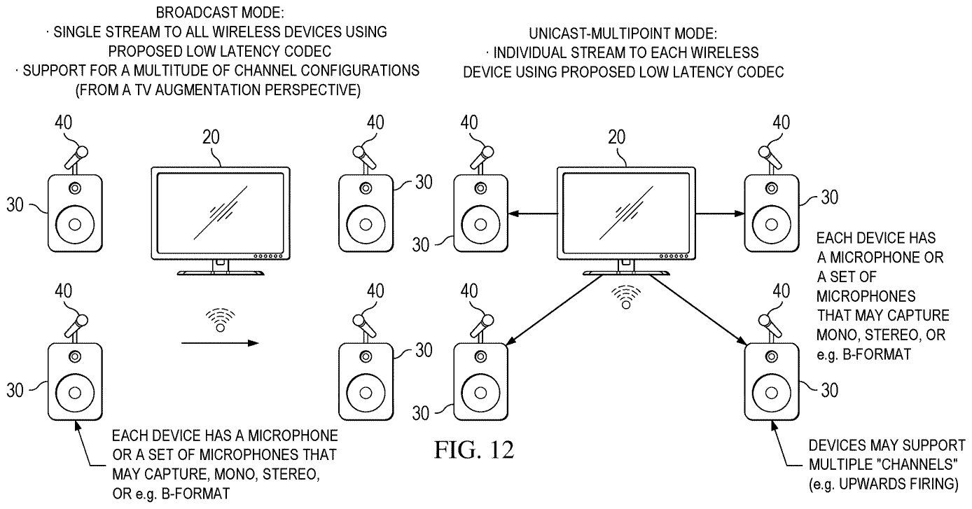

For play and listen use-cases, smart speakers 30 may have one or more microphones 40 (e.g., a microphone or a microphone array), which are configured to capture a mono or a spatial soundfield (e.g., in mono, stereo, A-format, B-format, or any other isotropic or anisotropic channel format), and there is a need for the codec to be able to do efficient coding of such formats in a low latency manner, so that the same codec is used for broadcast/transmission to the smart speaker device 30 as is used for the return channel, illustrated in for example FIG. 12.

It should also be noted, that while wake word detection is performed on the smart speaker device, the speech recognition typically is done in the cloud, with a suitable segment of recorded speech triggered by the wake word detection.

In this context it may be interesting to save system complexity overall by creating speech analytics systems on e.g., an intermediate format/representation within the codec. For the simplest use-case, where no human-to-human conversation is ongoing, a suitable representation can be defined specific to the speech recognition task, as it is not to be listened to by another human. This could be band energies, Mel-frequency Cepstral Coefficients (MFCCs) etc., or a low bitrate version of MDCT coded spectra.

In a use-case where there is human to human conversation ongoing, and there is a wake word and required speech recognition interleaved, one would either want to be able to extract the relevant parts of the stream for that. Such extraction could entail a layered coding structure, of simply additional data sent in parallel to the main speech signal. We also envision a defined transcode from the existing decoded MDCT spectra to the representation relevant, and in doing so simplifying the structure. Essentially a decoder would decode and output the human listenable audio until signaled that it should also decode (in parallel) the speech recognition representation. This representation can be “peeled off” a layered stream, simply an alternative decode of the same complete data, or simply the decode and output of an additional representation in the stream. In this use-case, the signaling is the enabling piece that indicates that the decoder on the receiving side should output a speech recognition relevant representation.

### Enumerated Examples

In the following, seven sets of enumerated example examples (EEE-As, EEE-Bs, EEE-Cs, EEE-Ds, EEE-Es, EEE-Fs, and EEE-Gs), which are not claims, describe aspects of the examples disclosed herein.
EEE-A1. A method for decoding an audio signal, the method comprising:
receiving a bitstream comprising at least one frame, wherein each frame of the at least one frames comprises a plurality of blocks;
determining, from signaling data, information to identify portions of one or more blocks of the plurality of blocks to be skipped over when decoding, based on device information of an output device; and
decoding the bitstream while skipping over the identified portions of the one or more blocks.
EEE-A2. The method of EEE-A1, wherein the information to identify portions of the one or more blocks of the plurality of blocks to be skipped over when decoding comprises a matrix that associates each output device of a plurality of output devices to one or more bitstream elements.
EEE-A3. The method of EEE-A2, wherein the one or more bitstream elements are required for the decoding of the bitstream for the corresponding associated output device.
EEE-A4. The method of any of EEE-A1 to EEE-A3, wherein the output device may comprise at least one of a wireless device, a mobile device, a tablet, a single-channel speaker, and/or a multi-channel speaker.
EEE-A5. The method of any of EEE-A1 to EEE-A4, wherein the identified portion comprises at least one block.
EEE-A6. The method of any of EEE-A1 to EEE-A5, wherein the output device is a first output device, further comprising applying joint coding techniques between one or more signals of the bitstream to a second output device and a third output device.
EEE-A7. The method of any of EEE-A1 to EEE-A6, wherein an identity of each output device and/or decoder is defined during a system initialization phase.
EEE-A8. The method of any of EEE-A1 to EEE-A7, wherein the signaling data is determined from metadata of the bitstream.
EEE-A9. An apparatus configured to perform the method of any one of EEE-A1 to EEE-A8.
EEE-A10. A non-transitory computer readable storage medium comprising a sequence of instructions which, when executed, cause one or more devices to perform the method of any one of EEE-A1 to EEE-A8.
EEE-B1. A method for generating an encoded bitstream from an audio program comprising a plurality of audio signals, the method comprising:
receiving, for each of the plurality of audio signals, information indicating a playback device with which the respective audio signal is associated;
receiving, for each playback device, information indicating at least one of a delay, a gain, and an equalization curve associated with the respective playback device;
determining, from the plurality of audio signals, a group of two or more related audio signals;
applying one or more joint-coding tools to the two or more related audio signals of the group to obtain jointly-coded audio signals;
combining the jointly-coded audio signals, an indication of the playback devices with which the jointly-coded audio signals are associated, and indications of the delay and the gain associated with the respective playback devices with which the jointly-coded audio signals are associated, into an independent block of an encoded bitstream.
EEE-B2. The method of EEE-B1, wherein the delay, gain, and/or equalization curve associated with the respective playback device depend on a location of the respective playback device relative to a location of a listener.
EEE-B3. The method of EEE-B1 or EEE-B2, wherein the delay, gain, and/or equalization curve associated with the respective playback device depend on a location of the respective playback device relative to locations of other playback devices.
EEE-B4. The method of any one of EEE-B1 to EEE-B3, wherein the delay, gain, and/or equalization curve are dynamically variable.
EEE-B5. The method of EEE-B4, wherein the delay, gain, and/or equalization curve are adjusted in response to a change in the location of the listener.
EEE-B6. The method of EEE-B4 or EEE-B5, wherein the delay, gain, and/or equalization curve are adjusted in response to a change in the location of the playback device.
EEE-B7. The method of any one of EEE-B4 to EEE-B6, wherein the delay, gain, and/or equalization curve are adjusted in response to a change in the location of one or more of the other playback devices.
EEE-B8. The method of any one of EEE-B1 to EEE-B7, further comprising determining, from the plurality of audio signals, an audio signal which is not part of the group of two or more related audio signals.
EEE-B9. The method of EEE-B8, further comprising, for the audio signal which is not part of the group of two or more related audio signals, applying the delay, gain, and/or equalization curve associated with the playback device with which the audio signal is associated.
EEE-B10. The method of EEE-B9, further comprising independently coding the audio signal which is not part of the group of two or more related audio signals, and combining the independently coded audio signal and an indication of the playback device with which the independently coded audio signal is associated into a separate independently decodable subset of the encoded bitstream.
EEE-B11. The method of EEE-B8, further comprising independently coding the audio signal which is not part of the group of two or more related audio signals, and combining the independently coded audio signal, an indication of the playback device with which the independently coded audio signal is associated, and an indication of the delay, gain, and/or equalization curve associated with the playback device with which the independently coded audio signal is associated into a separate independently decodable subset of the encoded bitstream.
EEE-B12. A method for decoding one or more audio signals associated with a playback device from a frame of an encoded bitstream, wherein the frame comprises one or more independent blocks of encoded data, the method comprising:
identifying, from the encoded bitstream, an independent block of encoded data corresponding to the one or more audio signals associated with the playback device;
extracting, from the encoded bitstream, the identified independent block of encoded data;
determining that the extracted independent block of encoded data includes two or more jointly-coded audio signals;
applying one or more joint-decoding tools to the two or more jointly-coded audio signals to obtain the one or more audio signals associated with the playback device;
determining, from the extracted independent block of encoded data, at least one of a delay, a gain, and an equalization curve associated with the playback device;
applying the delay, gain, and/or equalization curve associated with the playback device to the one or more audio signals associated with the playback device.
EEE-B13. The method of EEE-B12, wherein the determined delay, gain, and/or equalization curve associated with the playback device depend on a location of the playback device relative to a location of a listener.
EEE-B14. The method of EEE-B12 or EEE-B13, wherein the determined delay, gain, and/or equalization curve associated with the playback device depend on a location of the playback device relative to other playback devices.
EEE-B15. The method of any one of EEE-B12 to EEE-B14, wherein the determined delay, gain, and/or equalization curve of the playback device are dynamically variable.
EEE-B16. The method of EEE-B15, wherein, when the determined delay, gain, and/or equalization curve associated with the playback device differ from a previously determined delay, gain, and/or equalization curve associated with the playback device, the method further comprises interpolating between the previously determined delay, gain, and/or equalization curve associated with the playback device and the determined delay, gain, and/or equalization curve associated with the playback device.
EEE-B17. The method of EEE-B16, wherein the determined delay, gain, and/or equalization curve differs from the previously determined delay, gain, and/or equalization curve due to a change in the location of a listener.
EEE-B18. The method of EEE-B16 or EEE-B17, wherein the determined delay, gain, and/or equalization curve differ from the previously determined delay, gain, and/or equalization curve due to a change in the location of the playback device.
EEE-B19. The method of any one of EEE-B16 to EEE-B18, wherein the determined delay, gain, and/or equalization curve differ from the previously determined delay, gain, or equalization curve due to a change in the location of one or more of the other playback devices.
EEE-B20. The method of any one of EEE-B12 to EEE-B19, wherein the frame of the encoded bitstream comprises two or more independent blocks of encoded data, the method further comprising:
determining that one or more of the independent blocks contain audio signals not associated with the playback device; and
ignoring the one or more independent blocks that contain audio signals not associated with the playback device.
EEE-B21. The method of any one of EEE-B12 to EEE-B20, wherein applying one or more joint-decoding tools comprises identifying a subset of the jointly-coded audio signals that are associated with the playback device, and reconstructing only that subset of the jointly-coded audio signals to obtain the one or more audio signals associated with the playback device.
EEE-B22. The method of any one of EEE-B12 to EEE-B20, wherein applying one or more joint-decoding tools comprises reconstructing each of the jointly-coded audio signals, identifying a subset of the reconstructed jointly-coded audio signals associated with the playback device, and obtaining the one or more audio signals associated with the playback device from the subset of the reconstructed jointly-coded audio signals associated with the playback device.
EEE-B23. An apparatus configured to perform the method of any one of EEE-B1 to EEE-B22.
EEE-B24. A non-transitory computer readable storage medium comprising a sequence of instructions which, when executed, cause one or more devices to perform the method of any one of EEE-B1 to EEE-B22.
EEE-C1. A method for generating a frame of an encoded bitstream of an audio program comprising a plurality of audio signals, wherein the frame comprises two or more independent blocks of encoded data, the method comprising:
receiving, for one or more of the plurality of audio signals, information indicating a playback device with which the one or more audio signals are associated;
receiving, for the indicated playback device, information indicating one or more additional associated playback devices;
receiving one or more audio signals associated with the indicated one or more additional associated playback devices;
encoding the one or more audio signals associated with the playback device;
encoding the one or more audio signals associated with the indicated one or more additional associated playback devices;
combining the one or more encoded audio signals associated with the playback device and signaling information indicating the one or more additional associated playback devices into a first independent block;
combining the one or more encoded audio signals associated with the one or more additional associated playback devices into one or more additional independent blocks; and
combining the first independent block and the one or more additional independent blocks into the frame of the encoded bitstream.
EEE-C2. The method of EEE-C1, wherein the plurality of audio signals comprises one or more groups of audio signals not associated with the playback device or the one or more additional associated playback devices, further comprising:
encoding each of the one or more groups of audio signals not associated with the playback device or the one or more additional associated playback devices into a respective independent block; and
combining the respective independent block for each of the one or more groups into the frame of the encoded bitstream.
EEE-C3. The method of EEE-C1 or EEE-C2, wherein the one or more audio signals associated with the indicated one or more additional associated playback devices are specifically intended for use as echo-references for performing echo-management for the playback device.
EEE-C4. The method of EEE-C3, wherein the one or more audio signals intended for use as echo-references are transmitted using less data than the one or more audio signals associated with the playback device.
EEE-C5. The method of EEE-C3 or EEE-C4, wherein the one or more audio signals intended for use as echo-references encoded using parametric coding tools.
EEE-C6. The method of EEE-C1 or EEE-C2, wherein the one or more audio signals associated with the one or more other playback devices are suitable for playback from the one or more other playback devices.
EEE-C7. A method for decoding one or more audio signals associated with a playback device from a frame of an encoded bitstream, wherein the frame comprises two or more independent blocks of encoded data, wherein the playback device comprises one or more microphones, the method comprising:
identifying, from the encoded bitstream, an independent block of encoded data corresponding to the one or more audio signals associated with the playback device;
extracting, from the encoded bitstream, the identified independent block of encoded data;
extracting from the identified independent block of encoded data the one or more audio signals associated with the playback device;
identifying, from the encoded bitstream, one or more other independent blocks of encoded data corresponding to one or more audio signals associated with one or more other playback devices;
extracting from the one or more other independent blocks of encoded data the one or more audio signals associated with the one or more other playback devices;
capturing one or more audio signals using the one or more microphones of the playback device; and
using the one or more extracted audio signals associated with the one or more other playback devices as echo-references for performing echo-management for the playback device in response to the one or more captured audio signals.
EEE-C8. The method of EEE-C7, the method further comprising:
determining that the encoded bitstream comprises one or more additional independent blocks of encoded data; and
ignoring the one or more additional independent blocks of encoded data.
EEE-C9. The method of EEE-C8, wherein ignoring the one or more additional independent blocks of encoded data comprises skipping over the one or more additional independent blocks of encoded data without extracting the additional one or more independent blocks of encoded data.
EEE-C10. The method of any one of EEE-C7 to EEE-C9, wherein the one or more audio signals associated with the one or more other playback devices are specifically intended for use as echo-references for performing echo-management for the playback device.
EEE-C11. The method of EEE-C10, wherein the one or more audio signals specifically intended for use as echo-references are transmitted using less data than the one or more audio signals associated with the playback device.
EEE-C12. The method of EEE-C10 or EEE-C11, wherein the one or more audio signals specifically intended for use as echo-references are reconstructed from parametric representations of the one or more audio signals.
EEE-C13. The method of any one of EEE-C7 to EEE-C9, wherein the one or more audio signals associated with the one or more other playback devices are suitable for playback from the one or more other playback devices.
EEE-C14. The method of EEE-C7, wherein the encoded signal includes signaling information indicating the one or more other playback devices to use as echo-references for the playback device.
EEE-C15. The method of EEE-C14, wherein the one or more other playback devices indicated by the signaling information for a current frame differ from the one or more other playback devices used as echo-references for a previous frame.
EEE-C16. An apparatus configured to perform the method of any one of EEE-C1 to EEE-C15.
EEE-C17. A non-transitory computer readable storage medium comprising a sequence of instructions which, when executed, cause one or more devices to perform the method of any one of EEE-C1 to EEE-C15.
EEE-D1. A method for transmitting an audio signal, the method comprising:
generating packets of data comprising portions of a bitstream, wherein the bitstream comprises a plurality of frames, wherein each frame of the plurality of frames comprises a plurality of blocks, wherein the generating comprises:
assembling a packet of data with one or more blocks of the plurality of blocks, wherein blocks from different frames are combined into a single packet and/or are transmitted out of order; and
transmitting the packets of data via a packet-based network.
EEE-D2. The method of EEE-D1, wherein each block of the plurality of blocks comprises identifying information.
EEE-D3. The method of EEE-D2, wherein the identify information comprises at least one of a block ID, a corresponding frame number associated with the block, and/or a priority for retransmission.
EEE-D4. The method of any of EEE-D1 to EEE-D3, wherein each frame of the plurality of frames carries all audio data that represents a continuous segment of an audio signal with a start time, an end time, and a duration.
EEE-D5. A method for decoding an audio signal, the method comprising:
receiving packets of data comprising portions of a bitstream, wherein the bitstream comprises a plurality of frames, wherein each frame of the plurality of frames comprises a plurality of blocks;
determining a set of blocks of the plurality of blocks addressed to a device; and
decoding the set of blocks addressed to the device and skipping decoding the blocks of the plurality of blocks not addressed to the device.
EEE-D6. A method for transmitting an audio stream, the method comprising:
transmitting the audio stream, wherein the audio stream comprises a plurality of frames, wherein each frame of the plurality of frames comprises a plurality of blocks, wherein the transmitting comprises transmitting configuration information for the audio stream out of band.
EEE-D7. The method of EEE-D6, wherein transmitting configuration information for the audio stream out of band comprises:
transmitting the audio stream via a first network and/or a first network protocol; and
transmitting the configuration information via a second network and/or a second network protocol.
EEE-D8. The method of EEE-D7, wherein the first network protocol is a User Datagram Protocol (UDP) and the second network protocol is a Transmission Control Protocol (TCP).
EEE-D9. A method for decoding an audio signal, the method comprising:
receiving a bitstream that comprises:
information corresponding to a signaling of static configuration aspects;
static metadata; and
mapping one or more channel elements to one or more devices based on the information and/or static metadata.
EEE-D10. The method of EEE-D9, wherein the bitstream is received by a plurality of decoders configured to decode the bitstream, wherein each decoder of the plurality of decoders is configured to decode a portion of the bitstream.
EEE-D11. The method of EEE-D9 or EEE-D10, wherein the bitstream further comprises dynamic metadata.
EEE-D12. The method of any of EEE-D9 to EEE-D11, wherein the bitstream comprises a plurality of blocks, wherein each block of the plurality of blocks comprises:
information that enables for a portion of the block to be skipped during decoding, wherein the portion is not needed for a device; and
dynamic metadata.
EEE-D13. A method for re-transmitting blocks of an audio signal, the method comprising:
transmitting one or more blocks of a bitstream, wherein the bitstream comprises a plurality of blocks, wherein each of the one or more blocks of the bitstream has been previously transmitted; and
wherein each of the one or more blocks comprises a decoding priority indicator.
EEE-D14. The method of EEE-D13, wherein the decoding priority indicator indicates to a decoder an order of priority for decoding the one or more blocks of the bitstream.
EEE-D15. The method of EEE-D13 or EEE-D14, wherein each block of the one or more blocks comprises a same block ID.
EEE-D16. The method of any of EEE-D13 to EEE-D15, wherein the transmission of the one or more blocks of the bitstream is transmitted by reducing a data rate in comparison to the previous transmission.
EEE-D17. The method of EEE-D16, wherein reducing the data rate comprises at least one of reducing a signal to noise ratio of the audio signal, reducing a bandwidth of the audio signal, and/or reducing a channel count of the audio signal.
EEE-E1. A method for generating a frame of an encoded bitstream of an audio program comprising a plurality of audio signals, wherein the frame comprises one or more independent blocks of encoded data, the method comprising:
receiving, for each of the plurality of audio signals, information indicating a playback device with which the respective audio signal is associated;
encoding one or more audio signals associated with a respective playback device to obtain one or more encoded audio signals;
combining the one or more encoded audio signals associated with the respective playback device into a first independent block of the frame;
encoding one or more other audio signals of the plurality of audio signals into one or more additional independent blocks; and
combining the first independent block and the one or more additional independent blocks into the frame of the encoded bitstream.
EEE-E2. The method of EEE-E1, wherein two or more audio signals are associated with the playback device, and each of the two or more audio signals is a bandlimited signal intended for playback by a respective driver of the playback device, and wherein different encoding techniques are used for each of the bandlimited signals.
EEE-E3. The method of EEE-E2, wherein a different psychoacoustic model and/or a different bit allocation technique is used for each of the bandlimited signals.
EEE-E4. The method of any one of EEE-E1 to EEE-E3, wherein an instantaneous frame rate of the encoded signal is variable, and is constrained by a buffer fullness model.
EEE-E5. The method of EEE-E1, wherein encoding one or more audio signals associated with the respective playback device comprises jointly-encoding the one or more audio signals associated with the respective playback device and one or more additional audio signals associated with one or more additional playback devices into the first independent block of the frame.
EEE-E6. The method of EEE-E5, wherein jointly-encoding the one or more audio signals and one or more additional audio signals comprises sharing one or more scale factors across two or more audio signals.
EEE-E7. The method of EEE-E6, wherein the two or more audio signals are spatially related.
EEE-E8. The method of EEE-E7, wherein the two or more spatially related audio signals comprise left horizontal channels, left top channels, right horizontal channels, or right top channels.
EEE-E9. The method of EEE-E5, wherein jointly-encoding the one or more audio signals and one or more additional audio signals comprises applying a coupling tool comprising:
combining two or more audio signals into a composite signal above a specified frequency; and
determining, for each of the two or more audio signals, scale factors relating an energy of the composite signal and an energy of each respective signal.
EEE-E10. The method of EEE-E5, wherein jointly-encoding the one or more audio signals and one or more additional audio signals comprises applying a joint-coding tool to more than two signals.
EEE-E11. A method for decoding one or more audio signals associated with a playback device from a frame of an encoded bitstream, wherein the frame comprises one or more independent blocks of encoded data, the method comprising:
identifying, from the encoded bitstream an independent block of encoded data corresponding to the one or more audio signals associated with the playback device;
extracting, from the encoded bitstream, the identified independent block of encoded data;
decoding the one or more audio signals associated with the playback device from the independent block of encoded data to obtain one or more decoded audio signals;
identifying, from the encoded bitstream, one or more additional independent blocks of encoded data corresponding to one or more additional audio signals; and
decoding or skipping the one or more additional independent blocks of encoded data.
EEE-E12. The method of EEE-E11, wherein two or more audio signals are associated with the playback device, and each of the two or more audio signals is a bandlimited signal intended for playback by a respective driver of the playback device, and wherein different decoding techniques are used to decode the two or more audio signals.
EEE-E13. The method of EEE-E12, wherein a different psychoacoustic model and/or a different bit allocation technique was used to encode each of the bandlimited signals.
EEE-E14. The method of EEE-E11 or EEE-E13, wherein an instantaneous frame rate of the encoded bitstream is variable, and is constrained by a buffer fullness model.
EEE-E15. The method of EEE-E11, wherein decoding the one or more audio signals associated with the playback device comprises jointly-decoding the one or more audio signals associated with the respective playback device and one or more additional audio signals associated with one or more additional playback devices from the independent block of encoded data.
EEE-E16. The method of EEE-E15, wherein jointly-decoding the one or more audio signals and one or more additional audio signals comprises extracting scale factors shared across two or more audio signals.
EEE-E17. The method of EEE-E16 where the two or more audio signals are spatially related.
EEE-E18. The method of EEE-E17, wherein the two or more spatially related audio signals comprise left horizontal channels, left top channels, right horizontal channels, or right top channels.
EEE-E19. The method of EEE-E15, wherein jointly-decoding the one or more audio signals and one or more additional audio signals comprises applying a decoupling tool.
EEE-E20. The method of EEE-E19, wherein the decoupling tool comprises:
extracting independently decoded signals below a specified frequency;
extracting a composite signal above the specified frequency;
determining respective decoupled signals above the specified frequency from the composite signal and scale factors relating an energy of the composite signal and energies of respective signals; and
combining each independently decoded signal with a respective decoupled signal to obtain the jointly-decoded signals.
EEE-E21. The method of EEE-E15, wherein jointly-decoding the one or more audio signals and one or more additional audio signals comprises applying a joint-decoding tool to extract more than two audio signals.
EEE-E22. The method of EEE-E11, wherein decoding the one or more audio signals associated with the playback device comprises applying bandwidth extension to the audio signals in the same domain as the audio signals were coded.
EEE-E23. The method of EEE-E22, wherein the domain is a modified discrete cosine transform (MDCT) domain.
EEE-E24. The method of EEE-E22 or EEE-E23, wherein the bandwidth extension comprises adaptive noise addition.
EEE-E25. An apparatus configured to perform the method of any one of EEE-E1 to EEE-E24.
EEE-E26. A non-transitory computer readable storage medium comprising a sequence of instructions which, when executed, cause one or more devices to perform the method of any one of EEE-E1 to EEE-E24.
EEE-F1. A method, performed by a device with one or more microphones, for generating an encoded bitstream, the method comprising:
capturing, by the one or more microphones, one or more audio signals;
analyzing the captured audio signals to determine presence of a wake word;
upon detecting presence of a wake word:
setting a flag to indicate a speech recognition task is to be performed on the captured audio signals:
encoding the captured audio signals;
assembling the encoded audio signals and the flag into the encoded bitstream.
EEE-F2. The method of EEE-F1, wherein the one or more microphones are configured to capture a mono or a spatial soundfield.
EEE-F3. The method of EEE-F2, wherein the spatial soundfield is in an A-Format or a B-format.
EEE-F4. The method of any one of EEE-F1 to EEE-F3, wherein the captured audio signals are intended for use only in performing the speech recognition task.
EEE-F5. The method of EEE-F4, wherein the captured audio signals are encoded such that when the captured audio signals are decoded, the quality of the decoded audio signals is sufficient for performing the speech recognition task but is not sufficient for human listening.
EEE-F6. The method of EEE-F4 or EEE-F5, wherein the captured audio signals are converted to a representation comprising one or more of band energies, Mel-frequency Cepstral Coefficients, or Modified Discrete Cosine Transform (MDCT) spectral coefficients prior to encoding the captured audio signals.
EEE-F7. The method of any one of EEE-F1 to EEE-F3, wherein the captured audio signals are intended for both human listening and for use in performing the speech recognition task.
EEE-F8. The method of EEE-F7, wherein the captured audio signals are encoded such that when the captured audio signals are decoded, the quality of the decoded audio signals is sufficient for human listening.
EEE-F9. The method of EEE-F7, wherein encoding the captured audio signals comprises generating a first encoded representation of the captured audio signals and a second encoded representation of the captured audio signals, wherein the first encoded representation is generated such that when the captured audio signals are decoded from the first encoded representation, the quality of the decoded audio signals is sufficient for human listening, and wherein the second encoded representation is generated such that when the captured audio signal signals are decoded from the second encoded representation, the quality of the decoded audio signals is sufficient for performing the speech recognition task, but is not sufficient for human listening.
EEE-F10. The method of EEE-F9, wherein generating the second encoded representation of the captured audio signals comprises converting the captured audio signals to one or more of a parametric representation, a coarse waveform representation, or a representation comprising one or more of band energies, Mel-frequency Cepstral Coefficients, or Modified Discrete Cosine Transform (MDCT) spectral coefficients, prior to encoding the captured audio signals.
EEE-F11. The method of EEE-F9 or EEE-F10, wherein assembling the encoded audio signals into a bitstream comprises inserting the first encoded representation into a first independent block of the encoded bitstream, and inserting the second encoded representation into a second independent block of the encoded bitstream.
EEE-F12. The method of EEE-F9 or EEE-F10, wherein the first encoded representation is included in a first layer of the encoded bitstream, the second encoded representation is included in a second layer of the encoded bitstream, and the first and second layers are included in a single block of the encoded bitstream.
EEE-F13. The method of any one of EEE-F1 to EEE-F12, further comprising, when presence of the wake word is not detected:
setting the flag to indicate a speech recognition task is not to be performed on the captured audio signals;
encoding the captured audio signals;
assembling the encoded audio signals and the flag into the encoded bitstream.
EEE-F14. A method for decoding audio signal, comprising:
receiving an encoded bitstream comprising encoded audio signals and a flag indicating whether a speech recognition task is to be performed;
decoding the encoded audio signals to obtain decoded audio signals; and
when the flag indicates that the speech recognition task is to be performed, performing the speech recognition task on the decoded audio signals.
EEE-F15. The method of EEE-F14, wherein the decoded audio signals are intended for use only in performing the speech recognition task.
EEE-F16. The method of EEE-F15, wherein the quality of the decoded audio signals is sufficient for performing the speech recognition task but is not sufficient for human listening.
EEE-F17. The method of claim EEE-F15 or EEE-F16, wherein the decoded audio signals are in a representation comprising one or more of band energies, Mel-frequency Cepstral Coefficients, or Modified Discrete Cosine Transform (MDCT) spectral coefficients prior to encoding the captured audio signals.
EEE-F18. The method of EEE-F14, wherein the captured audio signals are encoded such that when the captured audio signals are decoded, the quality of the decoded audio signals is sufficient for human listening.
EEE-F19. The method of EEE-F18, wherein the encoded audio signals comprise a first encoded representation of one or more audio signals and a second encoded representation of the one or more audio signals.
EEE-F20. The method of EEE-F18, wherein the quality of audio signals decoded from the first representation is sufficient for human listening, and wherein the quality of audio signals decoded from the second representation is sufficient for performing the speech recognition task, but is not sufficient for human listening.
EEE-F21. The method of EEE-F19 or EEE-F20, wherein the first representation is in a first independent block of the encoded bitstream and the second representation is in a second independent block of the encoded bitstream.
EEE-F22. The method of EEE-F19 or EEE-F20, wherein the first representation is in a first layer of the encoded bitstream, the second encoded representation is included in a second layer of the encoded bitstream, and the first and second layers are included in a single block of the encoded bitstream.
EEE-F23. The method of any one of EEE-F18 to EEE-F22, wherein decoding the encoded audio signals comprises decoding only the second representation, and ignoring the first representation.
EEE-F24. The method of any one of EEE-F18 to EEE-F23, wherein audio signals decoded from the second encoded representation are in a parametric representation, a waveform representation, or a representation comprising one or more of band energies, Mel-frequency Cepstral Coefficients, or Modified Discrete Cosine Transform (MDCT) spectral coefficients.
EEE-F25. An apparatus configured to perform the method of any one of EEE-F1 to EEE-F24.
EEE-F26. A non-transitory computer readable storage medium comprising a sequence of instructions which, when executed, cause one or more devices to perform the method of any one of EEE-F1 to EEE-F24.
EEE-G1. A method for encoding audio signals of an immersive audio program for low latency transmission to one or more playback devices, the method comprising:
receiving a plurality of time-domain audio signals of the immersive audio program;
selecting a frame size;
extracting a frame of the time-domain audio signals in response to the frame size, wherein the frame of the time-domain audio signals overlaps with a previous frame of time-domain audio signals;
segmenting the audio signals into overlapping frames;
transforming the frame of time-domain audio signals to frequency-domain signals; coding the frequency-domain signals;
quantizing the coded frequency-domain signals using a perceptually motivated quantization tool;
assembling the quantized and coded frequency-domain signals into one or more independent blocks within the frame; and
assembling the one or more independent blocks into an encoded frame.
EEE-G2. The method of EEE-G1, wherein the plurality of audio signals comprise channel-based signals having a defined channel configuration.
EEE-G3. The method of EEE-G2, wherein the channel configuration is one of mono, stereo, 5.1, 5.1.2, 5.1.4, 7.1.2, 7.1.4, 9.1.6, or 22.2.
EEE-G4. The method of any one of EEE-G1 to EEE-G3, wherein the plurality of audio signals comprise one or more object-based signals.
EEE-G5. The method of any one of EEE-G1 to EEE-G4, wherein the plurality of audio signals comprise a scene-based representation of the immersive audio program.
EEE-G6. The method of any one of EEE-G1 to EEE-G5, wherein the selected frame size is one of 128, 256, 512, 1024, 120, 240, 480, or 960 samples.
EEE-G7. The method of any one of EEE-G1 to EEE-G6, wherein the overlap between the frame of time-domain audio signals and the previous frame of time-domain audios signal is 50% or lower.
EEE-G8. The method of any one of EEE-G1 to EEE-G7, wherein the transform is a modified discrete cosine transform (MDCT).
EEE-G9. The method of any one of EEE-G1 to EEE-G8, wherein two or more of the plurality of audio signals are jointly-coded.
EEE-G10. The method of any one of EEE-G1 to EEE-G9, wherein each independent block contains encoded signals for one or more playback devices.
EEE-G11. The method of any one of EEE-G1 to EEE-G10, wherein at least one independent block contains encoded signals for two or more playback devices, and the encoded signals comprise jointly-coded audio signals.
EEE-G12. The method of any one of EEE-G1 to EEE-G11, wherein at least one independent block contains a plurality of encoded signals covering different bandwidths intended for playback from different drivers of a playback device.
EEE-G13. The method of any one of EEE-G1 to EEE-G12, wherein at least one independent block contains an encoded echo-reference signal for use in echo-management performed by a playback device.
EEE-G14. The method of any one of EEE-G1 to EEE-G13, wherein coding the quantized frequency-domain signals comprises applying one or more of the following tools: temporal noise shaping (TNS), joint-channel coding, sharing of scale factors across signals, determining control parameters for high frequency reconstruction, and determining control parameters for noise substitution.
EEE-G15. The method of any one of EEE-G1 to EEE-G14, wherein one or more independent blocks include parameters for controlling one or more of delay, gain, and equalization of a playback device.
EEE-G16. A low latency method for decoding audio signals of an immersive audio program from an encoded signal, the method comprising:
receiving an encoded frame comprising one or more independent blocks;
extracting, from one or more independent blocks, quantized and coded frequency-domain signals;
dequantizing the quantized and coded frequency-domain signals;
decoding the dequantized frequency-domain signals;
inverse transforming the decoded frequency-domain signals to obtain time-domain signals; and
overlapping and adding the time-domain signals with time-domain signals from a previous frame to provide a plurality of audio signals of the immersive audio program.
EEE-G17. The method of EEE-G16, wherein the plurality of audio signals comprise channel-based signals having a defined channel configuration.
EEE-G18. The method of EEE-G17, wherein the channel configuration is one of mono, stereo, 5.1, 5.1.2, 5.1.4, 7.1.2, 7.1.4, 9.1.6, or 22.2.
EEE-G19. The method of any one of EEE-G16 to EEE-G18, wherein the plurality of audio signals comprise one or more object-based signals.
EEE-G20. The method of any one of EEE-G16 to EEE-G19, wherein the plurality of audio signals comprise a scene-based representation of the immersive audio program.
EEE-G21. The method of any one of EEE-G16 to EEE-G20, wherein a frame of time-domain samples comprises one of 128, 256, 512, 1024, 120, 240, 480, or 960 samples.
EEE-G22. The method of any one of EEE-G16 to EEE-G21, wherein the overlap with the previous frame is 50% or lower.
EEE-G23. The method of any one of EEE-G16 to EEE-G22, wherein the inverse transform is an inverse modified discrete cosine transform (IMDCT).
EEE-G24. The method of any one of EEE-G16 to EEE-G23, wherein each independent block contains quantized and coded frequency-domain signals for one or more playback devices.
EEE-G25. The method of any one of EEE-G16 to EEE-G24, wherein at least one independent block contains quantized and coded frequency-domain signals for two or more playback devices, and the quantized and coded frequency-domain signals are jointly-coded audio signals.
EEE-G26. The method of any one of EEE-G16 to EEE-G25, wherein at least one independent block contains a plurality of quantized and coded frequency-domain signals covering different bandwidths intended for playback from different drivers of a playback device.
EEE-G27. The method of any one of EEE-G16 to EEE-G26, wherein at least one independent block contains an encoded echo-reference signal for use in echo-management performed by a playback device.
EEE-G28. The method of any one of EEE-G16 to EEE-G27, wherein decoding the dequantized frequency-domain signals comprises applying one or more of the following decoding tools: temporal noise shaping (TNS), joint-channel decoding, sharing of scale factors across signals, high frequency reconstruction, and noise substitution.
EEE-G29. The method of any one of EEE-G16 to EEE-G28, wherein one or more independent blocks include parameters for controlling one or more of delay, gain, and equalization of a playback device.
EEE-G30. The method of any one of EEE-G16 to EEE-G29, wherein the method is performed by a playback device, and wherein extracting quantized and coded signals from one or more independent blocks comprises selecting only those blocks which contain quantized and coded frequency-domain signals for playback by the playback device, and ignoring independent blocks which contain quantized and coded frequency domain signals for playback by other playback devices.
EEE-G31. An apparatus configured to perform the method of any one of EEE-G1-EEE-G30.
EEE-G32. A non-transitory computer readable storage medium comprising a sequence of instructions which, when executed, cause one or more devices to perform the method of any one of EEE-G1 to EEE-G30.

In the claims below and the description herein, any one of the terms comprising, comprised of, or which comprises is an open term that means including at least the elements/features that follow, but not excluding others. Thus, the term comprising, when used in the claims, should not be interpreted as being limitative to the means or elements, or steps listed thereafter. For example, the scope of the expression of a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of examples of the invention, various features are sometimes grouped together in a single example, figure, or description thereof for the purpose of streamlining the disclosure and aiding in the understanding of one or more of the various inventive aspects. This method of disclosure, however, is not to be interpreted as reflecting an intention that more features are required than are expressly recited in each claim. Rather, as the following claims reflect, inventive aspects lie in less than all features of a single foregoing disclosed example. Thus, the claims following the Detailed Description are hereby expressly incorporated into this Detailed Description, with each claim standing on its own as a separate example of this invention.

Furthermore, while some examples described herein include some, but not other features included in other examples, combinations of features of different examples are meant to be encompassed, and form different examples, as would be understood by those skilled in the art. For example, in the following claims, any of the claimed examples can be used in any combination.

Furthermore, some of the examples are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus is an example of a means for carrying out the function performed by the element.

Furthermore, some of the examples described herein disclose connected solutions which should be interpreted as being possibly implemented in a distribution and/or transmission system such as a wired and/or wireless system. For example by use of any electrical, optical, and/or mobile system, such as 3G, 4G as well as 5G.

Thus, while there have been described specific examples of the invention, those skilled in the art will recognize that other and further modifications may be made, and it is intended to claim all such changes and modifications. For example, any formulas given above are merely representative of procedures that may be used. Functionality may be added or deleted from the block diagrams and operations may be interchanged among functional blocks. Steps may be added or deleted to the methods described.

Systems, devices, and methods disclosed hereinabove may be implemented as software, firmware, hardware, or a combination thereof. For example, aspects of the present application may be embodied, at least in part, in a device, a system that includes more than one device, a method, a computer program product, etc.

In a hardware implementation, the division of tasks between functional units referred to in the above description does not necessarily correspond to the division into physical units; to the contrary, one physical component may have multiple functionalities and one task may be carried out by several physical components in cooperation.

Certain components or all components may be implemented as software executed by a digital signal processor or microprocessor or be implemented as hardware or as an application-specific integrated circuit. Such software may be distributed on computer-readable media, which may comprise computer storage media (or non-transitory media) and communication media (or transitory media).

As is well known to a person skilled in the art, the term computer storage media includes both volatile and non-volatile, removable and non-removable media implemented in any method or technology for storage of information such as computer-readable instructions, data structures, program modules, or other data. Computer storage media includes but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by a computer.

Further, it is well known to the skilled person that communication media typically embodies computer-readable instructions, data structures, program modules, or other data in a modulated data signal such as a carrier wave or other transport mechanism and includes any information delivery media.

1. A method for generating a frame of an encoded bitstream of an audio program comprising a plurality of audio signals, wherein the frame comprises a plurality of independent blocks of encoded data, the method comprising:
receiving, for each of the plurality of audio signals, information indicating a playback device of a plurality of playback devices with which the respective audio signal is associated;
encoding one or more audio signals associated with a respective playback device of the plurality of playback devices to obtain one or more encoded audio signals;
combining the one or more encoded audio signals associated with the respective playback device into a first independent block of the frame;
encoding one or more other audio signals of the plurality of audio signals associated with one or more other playback devices of the plurality of playback devices into one or more additional independent blocks; and
combining the first independent block, the one or more additional independent blocks, and metadata indicating, for each independent block, one or more playback devices associated with the independent block, into the frame of the encoded bitstream.

2. The method of claim 1, wherein two or more audio signals are associated with the playback device, and each of the two or more audio signals is a bandlimited signal intended for playback by a respective driver of the playback device, and wherein different encoding techniques are used for each of the bandlimited signals.

3. The method of claim 2, wherein a different psychoacoustic model and/or a different bit allocation technique is used for each of the bandlimited signals.

4. The method of claim 1, wherein an instantaneous frame rate of the encoded signal is variable and constrained to obey buffer requirements.

5. The method of claim 1, wherein encoding one or more audio signals associated with the respective playback device comprises jointly-encoding the one or more audio signals associated with the respective playback device and one or more additional audio signals associated with one or more additional playback devices into the first independent block of the frame.

6-10. (canceled)

11. A method for decoding one or more audio signals associated with a playback device from a frame of an encoded bitstream, wherein the frame comprises a plurality of independent blocks of encoded data and metadata indicating, for each independent block, one or more playback devices associated with the independent block, the method comprising:
identifying, from the encoded bitstream based on the metadata, an independent block of encoded data corresponding to the one or more audio signals associated with the playback device;
extracting, from the encoded bitstream, the identified independent block of encoded data;
decoding the one or more audio signals associated with the playback device from the independent block of encoded data to obtain one or more decoded audio signals;
identifying, from the encoded bitstream based on the metadata, one or more additional independent blocks of encoded data corresponding to one or more additional audio signals; and
decoding or skipping the one or more additional independent blocks of encoded data.

12. The method of claim 11, wherein two or more audio signals are associated with the playback device, and each of the two or more audio signals is a bandlimited signal intended for playback by a respective driver of the playback device, and wherein different decoding techniques are used to decode the two or more audio signals.

13. The method of claim 12, wherein a different psychoacoustic model and/or a different bit allocation technique was used to encode each of the bandlimited signals.

14. The method of claim 12, wherein an instantaneous frame rate of the encoded bitstream is variable and constrained to obey buffer requirements.

15. The method of claim 11, wherein decoding the one or more audio signals associated with the playback device comprises jointly-decoding the one or more audio signals associated with the respective playback device and one or more additional audio signals associated with one or more additional playback devices from the independent block of encoded data.

16-21. (canceled)

22. The method of claim 11, wherein decoding the one or more audio signals associated with the playback device comprises applying bandwidth extension to the audio signals in the same domain as the audio signals were coded.

23-24. (canceled)

25. An apparatus configured to perform the method of claim 1.

26. A non-transitory computer readable storage medium comprising a sequence of instructions which, when executed, cause one or more devices to perform the method of claim 1.

27. An apparatus configured to perform the method of claim 11.

28. A non-transitory computer readable storage medium comprising a sequence of instructions which, when executed, cause one or more devices to perform the method of claim 11.
